(19) United States
(12) Patent Application Publication
(10) Pub. No.: US 2014/0303820 A1
(43) Pub. Date: Oct. 9, 2014

(54) HYBRID VEHICLE AND CONTROL METHOD THEREOF

(71) Applicants: Kazuma AOKI, Toyota-shi (JP); Koji HOKOI, Toyota-shi (JP); Hiroki ENDO, Nissin-shi (JP)

(72) Inventors: Kazuma AOKI, Toyota-shi (JP); Koji HOKOI, Toyota-shi (JP); Hiroki ENDO, Nissin-shi (JP)

(73) Assignee: TOYOTA JIDOSHA KABUSHIKI KAISHA, Toyota-shi (JP)

(21) Appl. No.: 14/245,380

(22) Filed: Apr. 4, 2014

(30) Foreign Application Priority Data
Apr. 8, 2013 (JP) 2013-080330

(51) Int. Cl. B60W 20/00; B60W 10/08; B60W 10/26; B60W 10/06

(52) U.S. Cl. CPC B60W 20/10; B60W 10/06; B60W 10/08; B60W 10/26; Y10S 903/93
USPC 701/22; 903/930; 180/65.265

(57) ABSTRACT

A hybrid vehicle includes an engine, a motor configured to generate electricity using a power from the engine, a battery configured to exchange an electric power with the motor, a switch configured to set a charging acceleration mode and to cancel the charging acceleration mode, a reporting device configured to report information, and an electronic control unit configured to (a) increase the electric power generated by the motor higher when the charging acceleration mode is set than that when the charging acceleration mode is not set, and (b) control the reporting device to notify that the charging acceleration mode is set.

### INCORPORATION BY REFERENCE

The disclosure of Japanese Patent Application No. 2013-080330 filed on Apr. 8, 2013 including the specification, drawings and abstract is incorporated herein by reference in its entirety.

### BACKGROUND OF THE INVENTION

1. Field of the Invention

The invention relates to a hybrid vehicle and a control method thereof. More particularly, the invention relates to a hybrid vehicle including an engine, a motor which generates electricity using power from the engine, and a battery which exchanges electric power with the motor, and to a control method thereof.

2. Description of Related Art

Conventionally, as a hybrid vehicle of this type, a hybrid vehicle has been proposed which includes an engine, a first motor generator which generates electricity with an output from the engine, a second motor generator used as an electric motor for generating a driving force for a vehicle, and an electrical storage device which exchanges electric power with the first and second motor generators and in which, when a charging request is sensed by a switch operation by a user, the engine and the first and second motor generators are controlled to set a control state of charge (SOC) lower than the actual SOC of the electrical storage device such that the SOC of the electrical storage device serves as the control SOC (see, e.g., Japanese Patent Application Publication No. 2011-93335 (JP 2011-93335 A)). In the vehicle, by such a control operation, opportunities for charging the electrical storage device are increased to implement vehicle driving responding to a user request.

### SUMMARY OF THE INVENTION

In the hybrid vehicle described above, when a destination is an area where, e.g., only a car which emits no exhaust gas is permitted to drive or the like, a user may want the battery to be charged until the power storage ratio of the battery reaches a target power storage ratio in preparation for motor driving during which the vehicle drives only with the power from the second motor generator without operating the engine. As a method which responds to such a request from the user, a method can be considered which charges the battery with the electric power resulting from the electricity generated by the first motor generator using the power from the engine when the user operates a predetermined switch to cause the power storage ratio of the battery to reach to the target power storage ratio. However, since the electricity is generated using the power from the engine, an amount of fuel consumption may increase to degrade fuel efficiency.

A hybrid vehicle and a control method thereof of the invention allow a user to recognize that, when a charging acceleration instruction switch which gives an instruction to increase the electric power generated by a motor is turned ON, a control operation which degrades fuel efficiency is performed.

A hybrid vehicle in an aspect of the invention includes an engine, a motor configured to generate electricity using a power from the engine, a battery configured to exchange an electric power with the motor, a switch (charging acceleration instruction switch) configured to set a charging acceleration mode and to cancel the charging acceleration mode, a reporting device configured to report information, and an electronic control unit configured to (a) increase the electric power generated by the motor higher when the charging acceleration mode is set (when the switch is ON) than that when the charging acceleration mode is not set (when the switch is OFF), and (b) control the reporting device to notify that the charging acceleration mode is set.

In the hybrid vehicle in the aspect of the invention, when the charging acceleration instruction switch is ON, the reporting device is controlled to notify an increase in the electric power generated by the motor. Since the motor generates electricity with the power from the engine, when the electric power generated by the motor increases, the amount of a fuel consumed in the engine also increases to degrade fuel efficiency. When the charging acceleration instruction switch is ON, by controlling the reporting device to be notified that the charging acceleration mode is ON, a user is allowed to recognize the increase in the electric power generated by the motor, an increase in the power from the engine, and an increase in the amount of fuel consumption, i.e., that a control operation which degrades fuel efficiency is performed.

In the hybrid vehicle in the aspect of the invention, the reporting device is means capable of displaying an image and the electronic control unit can also be means for controlling the reporting device such that, when the charging acceleration mode is set, a predetermined image is displayed on the reporting device. This can allow the user to visually recognize an increase in the amount of fuel consumption. In this case, the electronic control unit can also be means for controlling the reporting device such that, when the charging acceleration mode is set, a color of at least a part of the predetermined image is different from a color thereof when the charging acceleration mode is not set. The electronic control unit can also be means for controlling the reporting device such that, when the charging acceleration mode is set, at least a part of the predetermined image blinks.

In the hybrid vehicle in the aspect of the invention including the reporting device described above, the electronic control unit can also be means for controlling the reporting device to display, when the charging acceleration mode is set, an amount of a fuel to be consumed before an amount of the electric power stored in the battery reaches a target power storage amount. This can allow the user to recognize the amount of fuel consumption from the time when the charging acceleration instruction switch is turned ON before the amount of the electric power reaches the target power storage amount and prompt the user to determine whether or not the amount of electricity stored in the battery is to be increased even though the fuel is consumed thereby. In this case, the electronic control unit can also be means for controlling the reporting device to display a cost of the fuel consumed while the electric power generated by the motor is increased based on the amount of the consumed fuel and a unit price of the fuel. This can report to the user the cost of the fuel consumed while the electric power generated by the motor is increased and prompt the user to determine whether or not the amount of electricity stored in the battery is to be increased even though the fuel is consumed thereby.

In addition, the hybrid vehicle in the aspect of the invention is allowed to further include an external electric power supply device capable of supplying the electric power from the battery to an external device when the external device is connected thereto.

A control method for a hybrid vehicle in another aspect of the invention is for a hybrid vehicle including an engine, a motor configured to generate electricity using a power from the engine, a battery configured to exchange an electric power with the motor, a switch configured to set a charging acceleration mode and to cancel the charging acceleration mode, a reporting device configured to report information, and an electronic control unit, the control method including: increasing, by the electronic control unit, the electric power generated by the motor higher when the charging acceleration mode is set than that when the charging acceleration mode is not set; and controlling, by the electronic control unit, the reporting device to notify that the charging acceleration mode is set.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a configuration view showing the outline of a configuration of a hybrid car as an embodiment of the invention;

FIG. 2 is a flow chart showing an example of a switch-ON process routine which is executed by a hybrid electronic control unit (HVECU) of the embodiment;

FIG. 3 is an illustrative view showing an example of a target value selection screen which is displayed on a touch panel;

FIG. 4 is a flow chart showing an example of a fuel-consumption-related-information display process;

FIG. 5 is an illustrative view showing an example of the operation line of an engine and the setting of an estimated engine rotation number Neest and an estimated engine torque Teest;

FIG. 6 is an illustrative view showing an example of a fuel consumption rate map and the setting of a fuel consumption rate Rfuel;

FIG. 7 is an illustrative view showing an example of an energy information screen after a SOC recovery instruction switch displayed on the touch panel is pressed;

FIG. 8 is an illustrative view showing an example of a temporary charge/discharge power demand setting map;

FIG. 9 is an illustrative view showing an example of the energy information screen while a high-voltage battery displayed on the touch panel is charged;

FIG. 10 is a configuration view showing the outline of a configuration of a hybrid car in a modification;

FIG. 11 is a configuration view showing the outline of a configuration of a hybrid car in a modification;

FIG. 12 is a configuration view showing the outline of a configuration of a hybrid car in a modification; and

FIG. 13 is a configuration view showing the outline of a configuration of a hybrid car in a modification.

### DETAILED DESCRIPTION OF EMBODIMENTS

Next, a form for carrying out the invention will be described using an embodiment.

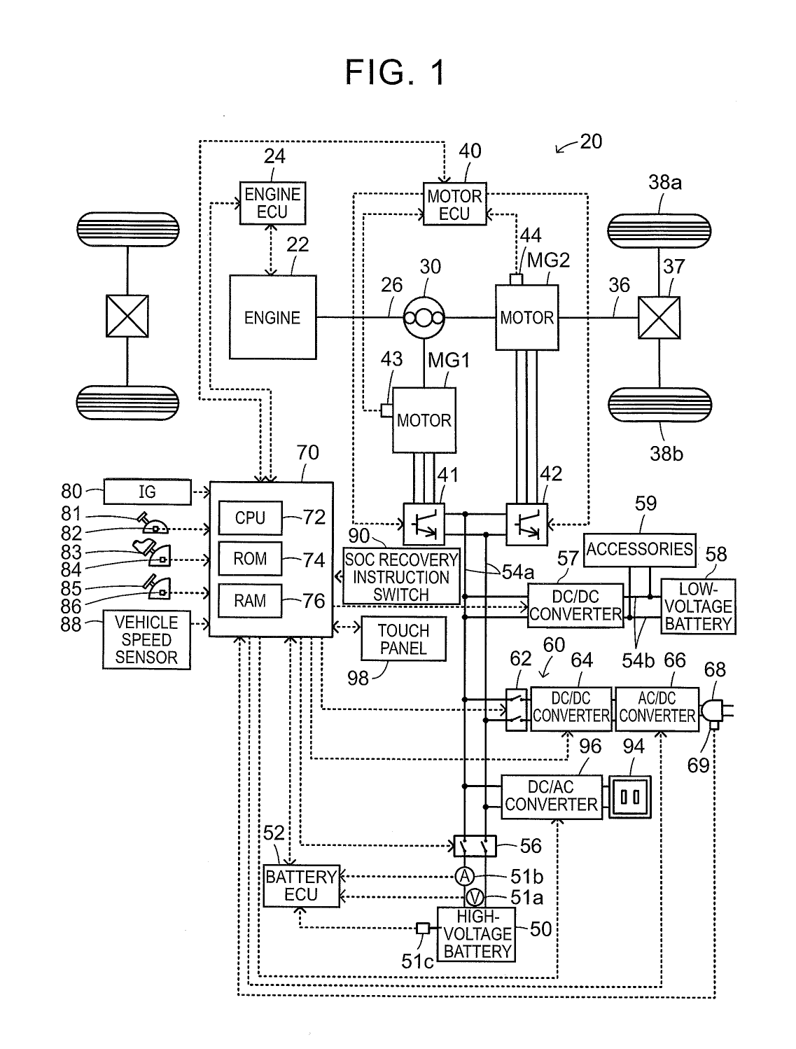

FIG. 1 is a configuration view showing the outline of a configuration of a hybrid car 20 as a first embodiment of the invention. As shown in FIG. 1, the hybrid car 20 in the first embodiment includes an engine 22, an engine electronic control unit (hereinafter referred to as the engine ECU) 24, a single-pinion planetary gear 30, a motor MG1, a motor MG2, inverters 41 and 42, a motor electronic control unit (hereinafter referred to as the motor ECU) 40, a high-voltage battery 50, a battery electronic control unit (hereinafter referred to as the battery ECU) 52, a charger 60, an electric outlet 94, a DC/AC converter 96, a touch panel 98, and a hybrid electronic control unit (hereinafter referred to as the HVECU) 70. The engine 22 outputs a power using gasoline, light oil, or the like as a fuel. The engine ECU 24 drive-controls the engine 22. The carrier of the planetary gear 30 is connected to a crankshaft 26 of the engine 22. The ring gear of the planetary gear 30 is connected to a drive shaft 36 coupled to drive wheels 38a and 38b via a differential gear 37. The motor MG1 is configured as, e.g., a synchronous power generating electric motor having a rotor thereof connected to the sun gear of the planetary gear 30. The motor MG2 is configured as, e.g., a synchronous power generating electric motor having a rotor thereof connected to the drive shaft 36. The inverters 41 and 42 drive the motors MG1 and MG2. The motor ECU 40 switching-controls the switching elements of the inverters 41 and 42, which are not shown, to drive-control the motors MG1 and MG2. The high-voltage battery 50 is configured as, e.g., a lithium ion secondary battery to exchange electric power with the motors MG1 and MG2 via the inverters 41 and 42. The battery ECU 52 manages the high-voltage battery 50. The charger 60 is connected to an external power source such as a household power source to be capable of charging the high-voltage battery 50. Into the electric outlet 94, the plug of an external device (such as, e.g., a household electric appliance) which is not a component of a vehicle can be inserted. When the plug of the external device is inserted in the electric outlet 94, the DC/AC converter 96 can convert a DC electric power in an electric power line 54 connected to the inverters 41 and 42 and the high-voltage battery 50 to an AC electric power at a predetermined voltage (such as, e.g., 100 V) and supply the AC electric power to the electric outlet 94 (external device). The touch panel 98 displays image information input thereto and also senses, when a user touches an image displayed on a screen with his or her hand or a dedicated pen, a touched screen position to output an information signal. The HVECU 70 controls the entire vehicle. Note that the electric outlet 94 and the DC/AC converter 96 correspond to the “external electric power supply device” of the invention.

The engine ECU 24 is configured as a microprocessor around a central processing unit (CPU), though not shown. The engine ECU 24 includes, in addition to the CPU, a read only memory (ROM) which stores a processing program, a random access memory (RAM) which temporarily stores data, an input/output port, and a communication port. To the engine ECU 24, signals from various sensors which detect the state of the engine 22 are input via an input port thereof. Examples of the signals input to the engine ECU 24 include respective singles for a crank position from a crank position sensor which detects the rotation position of the crankshaft 26, a cooling water temperature Tw from a water temperature sensor which detects the temperature of cooling water for the engine 22, a throttle position from a throttle valve position sensor which detects the position of a throttle valve, an intake air amount Qa from an air flow meter attached to an intake pipe, and the like. On the other hand, from the engine ECU 24, various control signals for driving the engine 22 are output via an output port thereof. Examples of the control signals output from the engine ECU 24 include a drive signal to a fuel injection valve, a drive signal to a throttle motor which adjusts the position of the throttle valve, a control signal to an ignition coil, and the like. The engine ECU 24 communicates with the HVECU 70 to control the operation of the engine 22 on the basis of the control signals from the HVECU 70 and output data related to the operating state of the engine 22 as necessary. Note that the engine ECU 24 also calculates the number of rotations of the crankshaft 26, i.e., the rotation number Ne of the engine 22 on the basis of the crank position from the crank position sensor.

The motor ECU 40 is configured as a microprocessor around a CPU, though not shown. The motor ECU 40 includes, in addition to the CPU, a ROM which stores a processing program, a RAM which temporarily stores data, an input/output port, and a communication port. To the motor ECU 40, signals required to drive-control the motor MG1 and M2 are input via an input port thereof. Examples of the signals input to the motor ECU 40 include signals for rotation positions θm1 and θm2 from rotation position detection sensors 43 and 44 which detect the rotation positions of the rotors of the motors MG1 and MG2, a phase current applied to the motors MG1 and MG2 and detected by a current sensor not shown, and the like. From the motor ECU 40, switching control signals to the switching elements of the inverters 41 and 42, which are not shown, and the like are output via an output port thereof. The motor ECU 40 communicates with the HVECU 70 to drive-control the motors MG1 and MG2 on the basis of the control signals from the HVECU 70 and output data related to the operating states of the motors MG1 and MG2 to the HVECU 70 as necessary. Note that the motor ECU 40 also calculates the rotation angular speeds ωm1 and ωm2 and rotation numbers Nm1 and Nm2 of the motors MG1 and MG2 on the basis of the rotation positions θm1 and θm2 of the rotors of the motors MG1 and MG2 from the rotation position detection sensors 43 and 33.

The battery ECU 52 is configured as a microprocessor around a CPU, though not shown. The battery ECU 52 includes, in addition to the CPU, a ROM which stores a processing program, a RAM which temporarily stores data, an input/output port, and a communication port. To the battery ECU 52, signal required to manage the high-voltage battery 50 are input. Examples of the signals input to the battery ECU 52 include signals for an inter-terminal voltage Vb from a voltage sensor 51a disposed between the terminals of the high-voltage battery 50, a charge/discharge current Ib from a current sensor 51b attached to the electric power line connected to an output terminal of the high-voltage battery 50, a battery temperature Tb from a temperature sensor 51c attached to the high-voltage battery 50, and the like. The battery ECU 52 transmits data related to the state of the high-voltage battery 50 to the HVECU 70 as necessary by communication. To manage the high-voltage battery 50, the battery ECU 52 also calculates a power storage ratio SOC which is the ratio of the capacity of an electric power that can be discharged from the high-voltage battery 50 to the entire capacity thereof of the moment on the basis of the cumulative value of the charge/discharge current Ib detected by the current sensor 51b and calculates input/output limits Win and Wout which are tolerable input/output electric powers with which the high-voltage battery 50 can be charged/discharged on the basis of the power storage ratio SOC and the battery temperature Tb that have been calculated. Note that the input/output limits Win and Wout of the high-voltage battery 50 can be set by setting the basic values of the input/output limits. Win and Wout on the basis of the battery temperature Tb, setting an output limit correction factor and an input limit correction factor on the basis of the power storage ratio SOC of the high-voltage battery 50, and multiplying the set basic values of the input/output limits Win and Wout by the correction factors.

The charger 60 is connected to a high-voltage-system electric power line 54a via a relay 62 and includes an alternating current-direct cunent (AC/DC) converter 66 which converts an AC electric power supplied from an external power source via a power source plug 68 to a DC electric power, and a DC/DC converter 64 which converts the voltage of the DC electric power from the AC/DC converter 66 to supply the resulting electric power toward the high-voltage-system electric power line 54a.

The HVECU 70 is configured as a microprocessor around a CPU, though not shown. The HVECU 70 includes, in addition to the CPU, a ROM which stores a processing program, a RAM which temporarily stores data, an input/output port, and a communication port. To the HVECU 70, various signals are input via an input port thereof, such as an ignition signal from an ignition switch 80, a signal for a shift position SP from a shift position sensor 82 which detects the operation position of a shift lever 81, a signal for an accelerator opening Acc from an accelerator pedal position sensor 84 which detects an amount of stepping on an accelerator pedal 83, a signal for a brake pedal position BP from a brake pedal position sensor 86 which detects an amount of stepping on a brake pedal 85, a signal for a vehicle speed V from a vehicle speed sensor 88, a signal for an external air temperature Tout from an external air temperature sensor 89, a SOC recovery instruction signal showing the ON/OFF state of a SOC recovery instruction switch 90, and an information signal from the touch panel 98. On the other hand, the HVECU 70 outputs image information to the touch panel 98. As described above, the HVECU 70 is connected to the engine ECU 24, the motor ECU 40, and the battery ECU 52 via the communication port to exchange various control signals and data with the engine ECU 24, the motor ECU 40, and the battery ECU 52. Note that the shift position SP includes a parking position (P position), a neutral position (N position), a drive position for forward driving (D position), a reverse position for rearward driving (R position), and the like.

In the hybrid car 20 in the embodiment thus configured, a demanded torque Tr* to be output to the drive shaft 36 is calculated on the basis of the accelerator opening Acc corresponding to the amount of stepping on the accelerator pedal by a driver and the vehicle speed V, and the engine 22 and the motors MG1 and MG2 are subjected to operation control so as to output a demanded power corresponding to the demanded torque Tr* to the drive shaft 36. The operation control of the engine 22 and the motors MG1 and MG2 is performed in operation modes such as a torque conversion operation mode, a charge/discharge operation mode, and a motor operation mode. In the torque conversion operation mode, the operation of the engine 22 is controlled so as to output a power comparable to the demanded power and the motors MG1 and MG2 are drive-controlled such that the whole power output from the engine 22 is converted by the planetary gear 30 and the motors MG1 and MG2 to a torque and the torque is output to the drive shaft 36. In the charge/discharge operation mode, the operation of the engine 22 is controlled to output a power comparable to the sum of the demanded power and an electric power required to charge/discharge the high-voltage battery 50 and the motors MG1 and MG2 are drive-controlled such that the demanded power is output to the drive shaft 36, while involving the torque conversion, by the planetary gear 30 and the motors MG1 and MG2, of the whole or a part of the power which is output from the engine 22 simultaneously with the charging/discharging of the high-voltage battery 50. In the motor operation mode, the operation control is performed such that the operation of the engine 22 is stopped and a power comparable to the demanded power from the motor MG2 is output to the drive shaft 36. Note that each of the torque conversion operation mode and the charge/discharge operation mode is a mode involving the operation of the engine 22 in which the engine 22 and the motors MG1 and MG2 are controlled so as to output the demanded power to the drive shaft 36. Since the torque conversion operation mode and the charge/discharge operation mode have no substantial difference therebetween in control, these two operation modes are hereinafter referred to as an engine operation mode.

In the hybrid car 20 in the embodiment, after the system of a vehicle is stopped at home or a preset charging point, when the power source plug 68 is connected to an external power source and the connection is detected by the connection detection sensor 69, a system main relay 55 and the relay 62 are turned ON and the charger 60 is controlled to charge the high-voltage battery 50 with the electric power from the external power source. When the system of the vehicle is activated after the charging of the high-voltage battery 50, the hybrid car 20 drives in a motor-driving-prioritized mode until the power storage ratio SOC of the high-voltage battery 50 reaches a threshold Shy (such as e.g., 20% or 30%). The threshold Shy has been set so as to allow the power storage ratio SOC of the high-voltage battery 50 to reach a value at which the engine 22 can be started. In the motor-driving-prioritized mode, motor driving which is performed using only the power from the motor MG2 is prioritized over hybrid driving which is performed using the power from the engine 22 and the power from the motor MG2. After the power storage ratio SOC of the high-voltage battery 50 reaches the threshold Shy, the hybrid car 20 drives in a hybrid-driving-prioritized mode in which the hybrid driving is prioritized over the motor driving.

In the motor-driving-prioritized mode, the demanded torque Tr* (to be output to the drive shaft 36) which is required of driving on the basis of the accelerator opening Acc corresponding to the amount of stepping on the accelerator pedal 83 and the vehicle speed V is set and a driving power Pdrv* required of driving is also calculated by multiplying the set demanded torque Tr* by a rotation number Nr (e.g., a rotation number obtained by multiplying the rotation number Nm2 of the motor MG2 or the vehicle speed V by a conversion factor) of the drive shaft 36. Then, when the driving power Pdrv* is not more than the output limit Wout of the high-voltage battery 50, the motor MG2 is controlled so as to output the driving power Pdrv* in a state where the operation of the engine 22 is stopped and thereby output the demanded torque Tr* to the drive shaft 36. As a result, the hybrid car 20 performs the motor driving. When the driving power Pdrv* exceeds the output limit Wout of the high-voltage battery 50, the engine 22 is started, the driving power Pdrv* is set to a demanded power Pe* to be output from the engine 22, and the engine 22 and the motors MG1 and MG2 are controlled such that the demanded power Pe* is output from the engine 22 and the demanded torque Tr* is output to the drive shaft 36. As a result, the hybrid car 20 performs the hybrid driving. Thereafter, when the driving power Pdrv* becomes not more than the output limit Wout of the high-voltage battery 50, the operation of the engine 22 is stopped and the hybrid car 20 returns to the motor driving which is performed by outputting the driving power Pdrv* from the motor MG2.

In the hybrid-driving-prioritized mode, a charge/discharge power demand Pb* (which has a negative value when the high-voltage battery 50 is discharged) of the high-voltage battery 50 is set in accordance with the power storage ratio SOC of the high-voltage battery 50 and the demanded power Pe* to be output from the engine 22 is set by adding the driving power Pdrv* to the set charge/discharge power demand Pb*. When the demanded power Pe* is not less than an operation threshold Pop determined in advance as a lowest power which allows the engine 22 to be operated relatively efficiently, the engine 22 and the motors MG1 and MG2 are controlled such that the demanded power Pe* is output from the engine 22 and the demanded torque Tr* is output to the drive shaft 36. As a result, the hybrid car 20 performs the hybrid driving. When the demanded power Pe* becomes less than the operation threshold Pop, the engine 22 cannot be operated relatively efficiently. In this case, the operation of the engine 22 is stopped and the hybrid car 20 shifts to the motor driving which is performed by outputting the driving power Pdrv* from the motor MG2. While the motor driving is performed, when the driver steps on the accelerator pedal 83 to increase the driving power Pdrv* and the demanded power Pe* becomes not less than the operation threshold Pop, the hybrid car 20 shifts to the hybrid driving which is performed by starting the engine 22 and outputting the demanded power Pe* from the engine 22. Note that the operation threshold Pop is determined to have a value considerably smaller than the output limit Wout of the high-voltage battery 50.

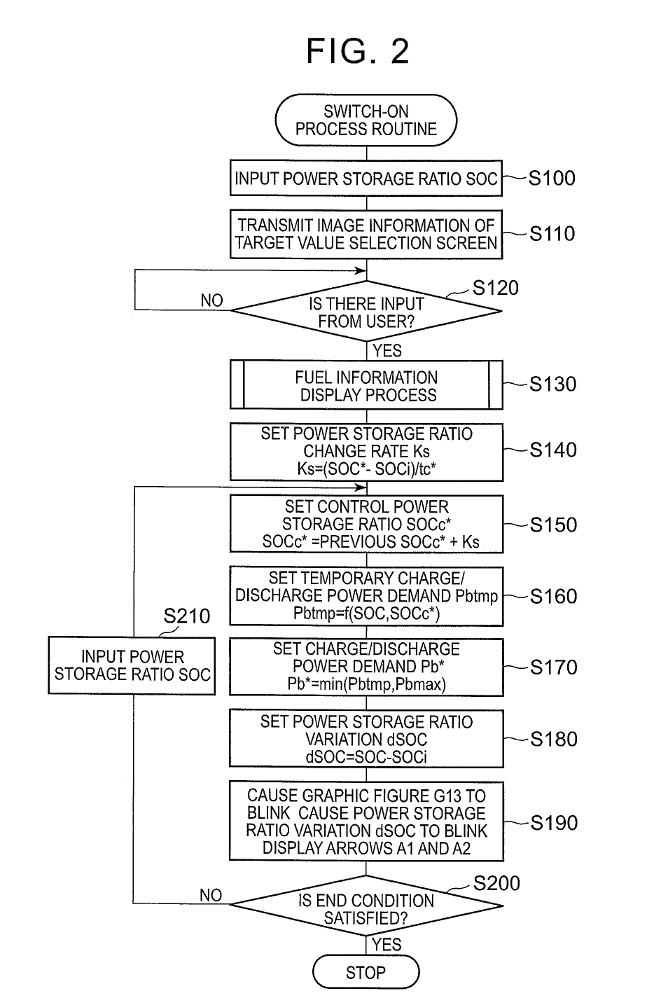

Next, a description will be given of the operation of the hybrid car 20 in the embodiment, especially the operation thereof when the SOC recovery instruction switch 90 is turned ON by a user. FIG. 2 is a flow chart showing an example of a switch-ON process routine which is executed by the HVECU 70. The routine is executed when the SOC recovery instruction switch 90 is turned ON by the user.

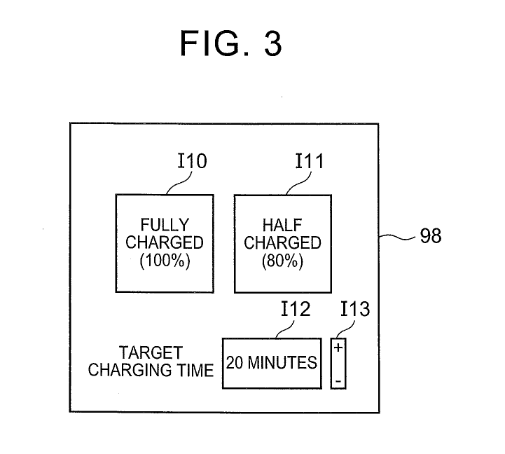

When the SOC-recovery-switch-ON process routine is executed, a CPU 72 of the HVECU 70 executes the process of inputting the power storage ratio SOC from the battery ECU 52 (Step S100), transmits the screen information of a target value selection screen for setting the target power storage ratio SOC* and a target charging time tc* to the touch panel 98 (step S110), and waits until the target power storage ratio SOC* and the target charging time tc* are input from the touch panel 98 (Step S120). The touch panel 98 that has received the image information in Step S110 displays the target value selection screen. FIG. 3 is an illustrative view showing an example of the target value selection screen displayed on the touch panel 98. On the touch panel 98, rectangular icons I10 and I11 including the characters “Fully Charged” and “Half Charged”, an icon I12 including characters showing a target charging time, and an icon I13 including the characters “+” and “−” are visually recognizably displayed. When the user touches one of the displayed icons I10 and I11, the touch panel 98 transmits, on the basis of the position information of the touched icon, information on the charged state shown by the touched icon as the target power storage ratio SOC* input by the user to the HVECU 70. The icon I13 is used so as to set the time shown by the icon I12. Every time the user touches the character “+” in the icon I13, the target time shown by the icon I12 increases. Every time the user touches the character “−” in the icon I13, the target time shown by the icon I12 decreases. When a state where the user does not touch the icon I13 is sustained for a predetermined time (e.g., 10 seconds or the like), the touch panel 98 transmits the time shown by the icon I13 as the target charging time tc* to the HVECU 70. At this time, it may also be possible to change the color of the one of the icons I10 and I11 touched by the user or cause the entire touched icon to blink.

When the target power storage ratio SOC* and the target charging time tc* are thus input, a fuel-consumption-related-information display process is executed (Step S130). Here, the description of the SOC-recovery-instruction-switch-ON process is temporarily halted and a description will be given of the fuel-consumption-related-information display process.

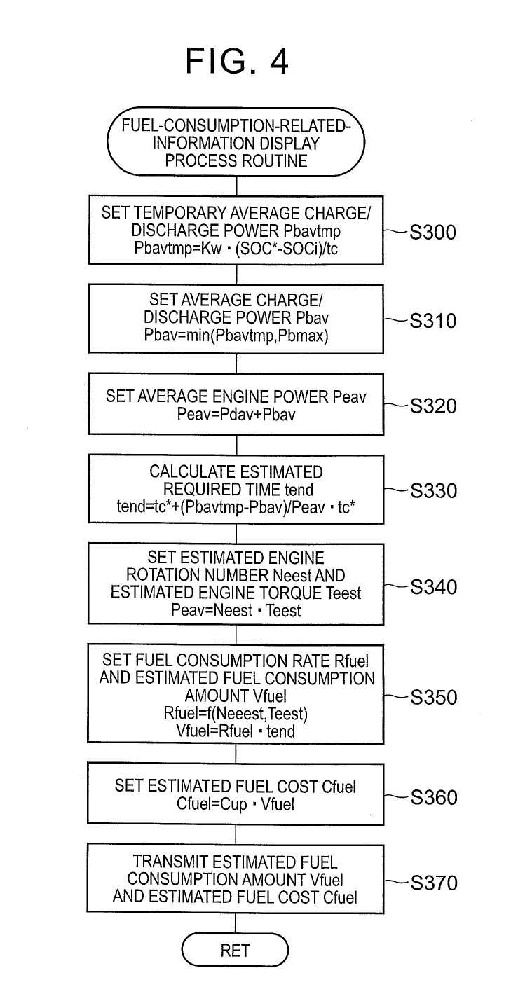

FIG. 4 is a flow chart showing an example of the fuel-related-information display process. In the fuel-related-information display process, using the following expression (1), a power required in a unit time in the high-voltage battery 50 for the charging/discharging thereof to allow a charge-storage-ratio initial value SOCi, which is the current power storage ratio SOC, to reach the target power storage ratio SOC* in the target charging time tc* is set as a temporary average charging/discharging power Pbavtmp (Step S300). Of the respective values of the temporary average charging/discharging power Pbavtmp and an upper-limit charging power Pbmax which is the maximum value of the charging electric power tolerated by the high-voltage battery 50, the smaller one is set as an average charging/discharging power Pbav (Step S310). Here, in the expression (1), “Kw” is a conversion factor for converting the power storage ratio SOC of the high-voltage battery 50 to an electric power (power):

Pbavtmp=Kw·(SOC*−SOCi)/tc* (1).

When the average charging/discharging power Pbav is thus set, a power which is the sum of an expected driving power Pdav expected to be an average value of the driving power of the vehicle when the high-voltage battery 50 is charged after the SOC recovery instruction switch 90 is turned ON and the average charging/discharging power Pbav is set as an average engine power Peav (Step S320). Using the target charging time tc*, the average charging/discharging power Pbav, the temporary average charging/discharging power Pbavtmp, and the expected driving power Pdav, an estimated required time tend estimated to be a time required by the power storage ratio SOC to reach the target power storage ratio SOC* when the vehicle drives with the expected driving power Pdav after the SOC recovery instruction switch 90 is turned ON is calculated in accordance with the following expression (2) (Step S330). Here, the expected driving power Pdav uses the average value of the driving power demand Pdrv* based on the accelerator opening Acc and the vehicle speed V in one trip from the previous turning ON of the ignition switch 80 to the previous turning OFF thereof. The reason for calculating the estimated required time tend here is that, since the high-voltage battery 50 is allowed to be charged only with the upper-limit charging power Pbmax at most, an actual time required by the power storage ratio SOC to reach the target power storage ratio SOC* after the SOC recovery instruction switch 90 is turned ON may not match the target charging time tc* input by the user. When the estimated required time tend is calculated, by using the average value of the driving power demand Pdrv* in one trip from the previous turning ON of the ignition switch 80 to the previous turning OFF thereof, the driving pattern of an individual user such as a way to operate the accelerator or the like can be reflected in the calculation result and therefore the estimated required time tend can more accurately be calculated:

tend=tc*+(Pbavtmp−Pbav)·tc*/(Pdav+Pbav) (2).

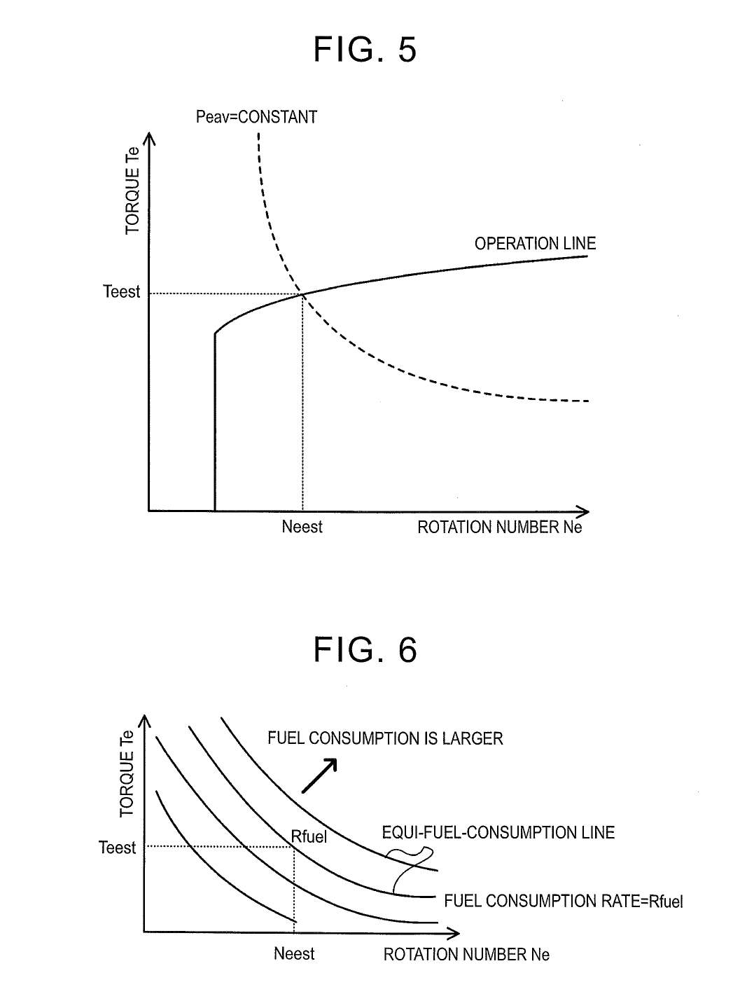

When the estimated predetermined time tend is thus calculated, then an estimated engine rotation number Neest and an estimated engine torque Teest as operation points at which the engine 22 is to be operated are set on the basis of the set average engine power Peav (Step S340). The setting is performed on the basis of the operation line which allows the engine 22 to be efficiently operated and the average engine power Peay. FIG. 5 shows an example of the operation line of the engine 22 and the setting of the estimated engine rotation number Neest and the estimated engine torque Teest. As shown in the drawing, the estimated engine rotation number Neest and the estimated engine torque Teest can be determined from the intersection point of the operation line with the curve with the constant average engine power Peav (Neest×Teest).

When the estimated engine rotation number Neest and the estimated engine torque Teest are thus set, a fuel consumption rate Rfuel of the engine 22 is set on the basis of the estimated engine rotation number Neest and the estimated engine torque Teest, while a value obtained by multiplying the fuel consumption rate Rfuel by the estimated required time tend is set to an estimated fuel consumption amount Vfuel of the engine 22 (Step S350). The fuel consumption rate Rfuel is set on the basis of the estimated engine rotation number Neest, the estimated engine torque Teest, and the fuel consumption rate map stored in a ROM 74. FIG. 6 shows an example of the fuel consumption rate map and the setting of the fuel consumption rate Rfuel. As shown in the drawing, the fuel consumption rate Rfuel is set as a fuel consumption rate corresponding thereto when the estimated engine rotation number Neest and the estimated engine torque Teest are given.

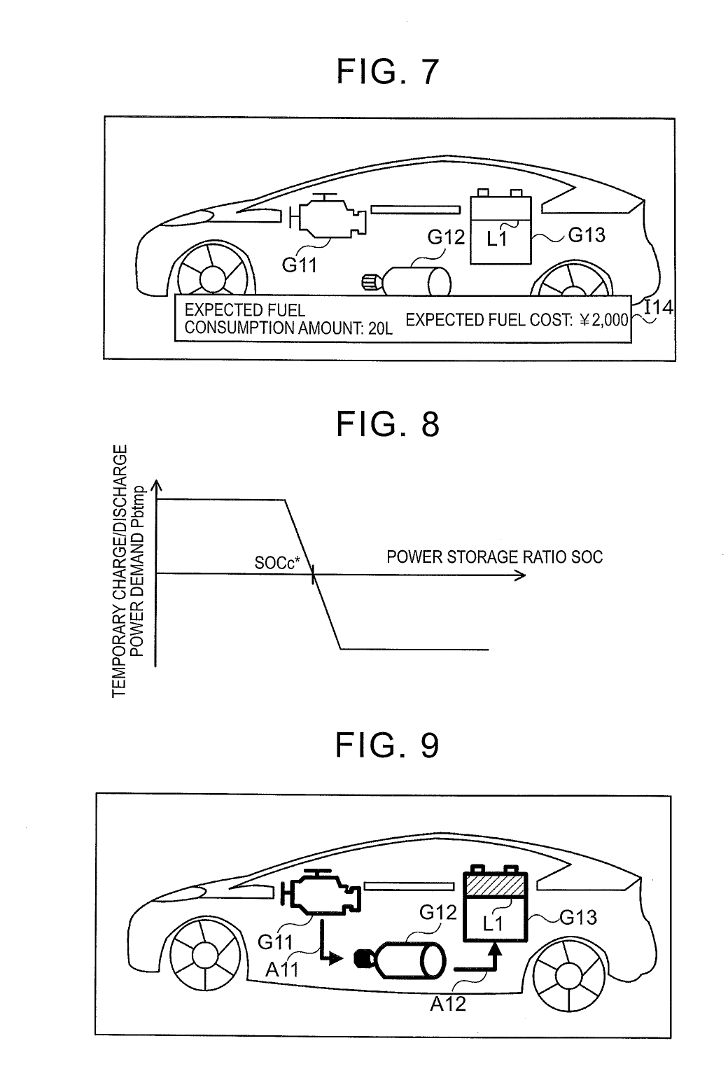

When the fuel consumption rate Rfuel is thus set, a value obtained by multiplying a fuel unit price Cup stored in advance in the ROM 74 by the set estimated fuel consumption amount Vfuel is set as an estimated fuel cost Cfuel (Step S360), image information is transmitted to the touch panel 98 such that the set estimated fuel consumption amount Vfuel and the estimated fuel cost Cfuel are displayed on the touch panel 98 (Step S370), and the main routine is ended. The touch panel 98 that has received the image information executes the process of displaying the estimated fuel consumption amount Vfuel and the estimated fuel cost Cfuel each set to an energy information screen. FIG. 7 is an illustrative view showing an example of the energy information screen displayed on the touch panel 98. The touch panel 98 visually recognizably displays graphic figures G11 to G13 showing the engine, the motor MG1, and the high-voltage battery 50 and a rectangular icon I14 including the characters “Expected Fuel Consumption Amount: 20 L, Expected Fuel Cost: 2000 Yen” showing the expected fuel consumption amount Vfuel and the expected fuel cost Cfuel. The graphic figure G13 shows a line L1 so as to allow the user to recognize the current remaining capacity SOC of the high-voltage battery 50. The individual numbers in the icon I14 show the expected fuel consumption amount Vfuel and the expected fuel cost Cfuel that have been set. This can allow the user to recognize the amount and cost of the fuel estimated to be consumed from the time when the SOC recovery instruction switch 90 is turned ON until the power storage ratio SOC of the high-voltage battery 50 reaches the target power storage ratio SOC* and prompt the user to determine whether or not the amount of the electric power stored in the battery is to be increased even though the fuel is consumed thereby. Thus, the fuel-consumption-related-information display process has been described heretofore.

Returning to the description of the SOC-recovery-instruction-switch-ON process, when the fuel-consumption-related-information display process is thus executed (Step S130), then a value obtained by subtracting the charge-storage-ratio initial value SOCi from the input target power storage ratio SOC* is divided by the target charging time tc* to set a charge-storage-ratio change rate Ks (Step S140). Then, a value obtained by adding the charge-storage-ratio change rate Ks to the control target power storage ratio SOCc* is set again to the control target power storage ratio SOCc* (Step S150). Here, to the control target power storage ratio SOCc*, the power storage ratio SOC input in the process in Step S100 is set as an initial value.

When the control target charge storage rate SOCc* is thus set, a temporary charge/discharge power demand Pbtmp is set to allow the power storage ratio SOC to reach the control target power storage ratio SOCc* using the current power storage ratio SOC of the high-voltage battery 50, the control target power storage ratio SOCc*, and the temporary charge/discharge power demand setting map stored in the ROM 74 (Step S160). FIG. 8 shows an example of the temporary charge/discharge power demand setting map. As shown in the drawing, when the power storage ratio SOC is higher than the control target power storage ratio SOCc*, a power having a negative value the absolute value of which tends to increase as the difference between the control target power storage ratio SOCc* and the power storage ratio SOC increases is set to the temporary charge/discharge power demand Pbtmp so as to eliminate the difference therebetween. When the power storage ratio SOC is lower than the control target power storage ratio SOCc*, a power having a positive value which tends to increase as the difference between the control target power storage ratio SOCc* and the power storage ratio SOC increases is set to the temporary charge/discharge power demand Pbtmp so as to eliminate the difference therebetween. By thus setting the temporary charge/discharge power demand Pbtmp, the power storage ratio SOC is allowed to reach the control target power storage ratio SOCc*. Note that the temporary charge/discharge power demand setting map is stored in the ROM 74 for each of the control target power storage ratio SOCc* on a one-by-one basis.

When the temporary charge/discharge power demand Pbtmp is thus set, the value of the lower one of the temporary charge/discharge power demand Pbtmp and the upper-limit charging power Pbmax used in Step S310 of the fuel-consumption-related-information display process routine of FIG. 4 is set as the charge/discharge power demand Pb* (Step S170). When the charge/discharge power demand Pb* is thus set, in accordance with the hybrid-driving-prioritized mode described above, the engine 22 and the motors MG1 and MG2 are controlled such that the hybrid car 20 drives, while outputting a power obtained by adding the driving power Pdrv* to the set charge/discharge power demand Pb* from the engine 22. This can allow the hybrid car 20 to drive, while charging the high-voltage battery 50 with the electric power generated from the motor MG1 using the power output from the engine 22.

Subsequently, a value obtained by subtracting the charge-storage-ratio initial value SOCi from the current power storage ratio SOC is set as the charge-storage-ratio variation dSOC (Step S180), and image information is transmitted to the touch panel 98 such that, on the energy information screen described above, the graphic figure G13 showing the high-voltage battery 50 in the touch panel 98 blinks, the range in the graphic figure G13 extending from the line L1 showing the charge-storage-ratio initial value SOCi to the charge-storage-ratio variation dSOC blinks, and an arrow A11 showing that energy is output from the graphic figure G11 showing the engine 22 to the graphic figure G12 showing the motor MG1 and an arrow A12 showing that energy is output from the graphic figure G12 showing the motor MG1 to the graphic figure G13 showing the high-voltage battery 50 are displayed (Step S190). The touch panel 98 that has received the image information executes the process of causing the graphic figure G13 showing the high-voltage battery 50 to blink on the energy information screen, causing the range in the graphic figure G13 extending from the line L1 showing the charge-storage-ratio initial value SOCi to the charge-storage-ratio variation dSOC to blink thereon, and displaying the arrow A11 extending from the graphic figure G11 to the graphic figure G12 and the arrow A12 extending from the graphic figure G12 to the graphic figure G13 thereon. FIG. 9 shows an example of the energy information screen. Since the motor MG1 generates electricity with the power from the engine 22, when the electric power generated by the motor MG1 increases, the amount of fuel consumption increases to degrade the fuel efficiency of the vehicle. This can allow the user to visually recognize, while the high-voltage battery 50 is charged with the electric power generated by the motor MG1 that is driven using the power from the engine 22, that such a control operation is performed, i.e., a control operation of the type which degrades fuel efficiency is performed and how much the power storage ratio SOC of the high-voltage battery 50 has changed from the charge-storage-ratio initial value SOCi.

When the energy information screen is thus displayed, it is subsequently examined whether or a predetermined end condition has been satisfied in such a case as when the SOC recovery instruction switch 90 is turned OFF or when the power storage ratio SOC of the high-voltage battery 50 has reached the target power storage ratio SOC* (Step S200). When the predetermined end condition has not been satisfied, the power storage ratio SOC is input from the battery ECU 52 (Step S210) and the main process returns to the process in Step S150. Then, the process in Steps S140 to S210 is repeated until the predetermined end condition is satisfied. Specifically, in the repeated process, a value obtained by adding the charge-storage-ratio change rate Ks to the control target power storage ratio SOCc* is set again to the control target power storage ratio SOCc*, the temporary charge/discharge power demand Pb* is set using the power storage ratio SOC of the high-voltage battery 50, the control target power storage ratio SOCc*, and the charge/discharge power demand setting map stored in the ROM 74, and the value of the lower one of the temporary charge/discharge power demand Pbtmp and the upper-limit charging power Pbmax is set as the charge/discharge power demand Pb*. In addition, on the energy information screen, the graphic figure G13 and the range in the graphic figure G13 extending from the line L1 showing the charge-storage-ratio initial value SOCi to the charge-storage-ratio variation dSOC are caused to blink, the arrows A1 and A2 are displayed, and the power storage ratio SOC is input from the battery ECU 52. By such a process, the high-voltage battery 50 is charged with a power within the range of the upper-limit charging/discharging power Pbmax. Therefore, it is possible to change the power storage ratio SOC toward the target power storage ratio SOC*. At this time, the power storage ratio SOC can be changed in a variation based on the charge-storage-ratio change rate Ks set using the target charging time tc* input by the user. This can allow the power storage ratio SOC to reach the target power storage ratio SOC* in the target charging time tc* input by the user and allow the power storage ratio SOC to reach the target power storage ratio SOC* with a timing closer to a timing desired by the user.

When the predetermined end condition is satisfied while such a process is executed (Step S200), the main routine is ended.

In the hybrid car 20 in the embodiment described above, when the SOC recovery instruction switch 90 is ON, the engine 22 and the motors MG1 and MG2 are controlled so as to increase the power storage ratio SOC while, on the energy information screen of the touch panel 98, the graphic figure G13 showing the high-voltage battery 50 is caused to blink, the range in the graphic figure G13 extending from the line L1 showing the charge-storage-ratio initial value SOCi to the charge-storage-ratio variation dSOC is caused to blink, and the arrows A11 and A22 are displayed. This can allow the user to visually recognize that a control operation of the type which degrades fuel efficiency is performed.

In addition, when the SOC recovery instruction switch 90 is turned ON, the touch panel 98 is controlled so as to display the expected fuel consumption amount Vfuel and the expected fuel cost Cfuel. This can allow the user to visually recognize the amount and cost of the fuel which is expected to be consumed while the engine 22 and the motors MG1 and MG2 are controlled so as to increase the power storage ratio as the ratio of the capacity of the electric power that can be discharged from the high-voltage battery 50 to the entire capacity thereof and prompt the user to determine whether or not the power storage ratio SOC of the high-voltage battery 50 is to be increased even though the fuel is consumed thereby.

In the hybrid car 20 in the embodiment, on the energy information screen of the touch panel 98, the graphic figure G13 showing the high-voltage battery 50 is caused to blink and the range in the graphic figure G13 extending from the line L1 showing the charge-storage-ratio initial value SOCi to the charge-storage-ratio variation dSOC is caused to blink. However, it may also be possible that the graphic figure G13 has a color different from that when the SOC recovery instruction switch 90 is OFF or the range in the graphic figure G13 extending from the line L1 showing the charge-storage-ratio initial value SOCi to the charge-storage-ratio variation dSOC has a color different from the color of the other range in the graphic figure G13.

In the hybrid car 20 in the embodiment, the fuel consumption amount Vfuel and the fuel cost Cfuel are displayed on the touch panel 98. However, the fuel consumption amount Vfuel and the fuel cost Cfuel are not limited to those displayed on the touch panel 98 described above. The fuel consumption amount Vfuel and the fuel cost Cfuel may also be reported from a speaker not shown to the user by voice/sound.

In the hybrid car 20 in the embodiment, on the energy information screen shown by way of example in FIG. 7, the graphic figures G11 to G13 and the line L1 are displayed. However, it may also be possible that the graphic figures G11 to G13 and the line L1 are not displayed, but only the icon I14 is displayed.

In the hybrid car 20 in the embodiment, on the energy information screen shown by way of example in FIG. 9, the graphic figure G13 is caused to blink, the range in the graphic figure G13 extending from the line L1 showing the charge-storage-ratio initial value SOCi to the charge-storage-ratio variation dSOC is caused to blink, and the arrows A11 and A12 are displayed. However, any energy information screen can be used as long as the user is allowed to visually recognize that the engine 22 and the motors MG1 and MG2 are controlled so as to increase the power storage ratio SOC of the high-voltage battery 50, i.e., that the electric power generated by the motor MG1 is increased, the power from the engine 22 increases, or the amount of fuel consumption in the engine 22 increases, i.e., that a control operation which degrades fuel efficiency is performed. For example, it may also be possible that the arrows A11 and A12 are displayed on the energy information screen, while the graphic figure G13 is not caused to blink thereon, that the entire graphic figure G13 is not caused to blink, but only the range in the graphic figure G13 extending from the line L1 showing the charge-storage-ratio initial value SOCi to the charge-storage-ratio variation dSOC is caused to blink and the arrows A11 and A12 are not displayed, or that the color of the entire energy information screen changes into a specific color.

In the hybrid car 20 in the embodiment, in the process of Step S330, the estimated required time tend is calculated using the target charging time tc*, the average charging/discharging power Pbav, the temporary average charging/discharging power Pbavtmp, and the estimated driving power Pdav. However, it may also be possible that the relationship among the target storage ratio SOC* and the target charging time tc, each input by the user, the power storage ratio SOC, and the estimated required time tend is determined in advance by experiment, analysis, or the like and the estimated required time tend is derived from the determined relationship when the target power storage ratio SOC*, the target charging time tc, and the charging ratio SOC are given.

In the hybrid car 20 in the embodiment, when the SOC recovery instruction switch 90 is turned ON, the engine 22 and the motors MG1 and MG2 are controlled so as to increase the power storage ratio SOC of the high-voltage battery 50 toward the target power storage ratio SOC*. However, when the SOC recovery instruction switch 90 is turned ON, it is sufficient if the electric power generated by the motor MG1 is higher than that before the SOC recovery instruction switch 90 is turned ON. Accordingly, when the SOC recovery instruction switch 90 is turned ON, it may also be possible to, e.g., set the threshold of the driving power Pdrv* when the operation of the engine 22 is stopped lower than the output limit Wout such that the operation of the engine 22 is less likely to be stopped or further add a power having a predetermined value to the charge/discharge power demand Pb* to which the driving power Pdrv* has been added such that the demanded power Pe* to be output from the engine 22 is higher than before the SOC recovery instruction switch 90 is turned ON.

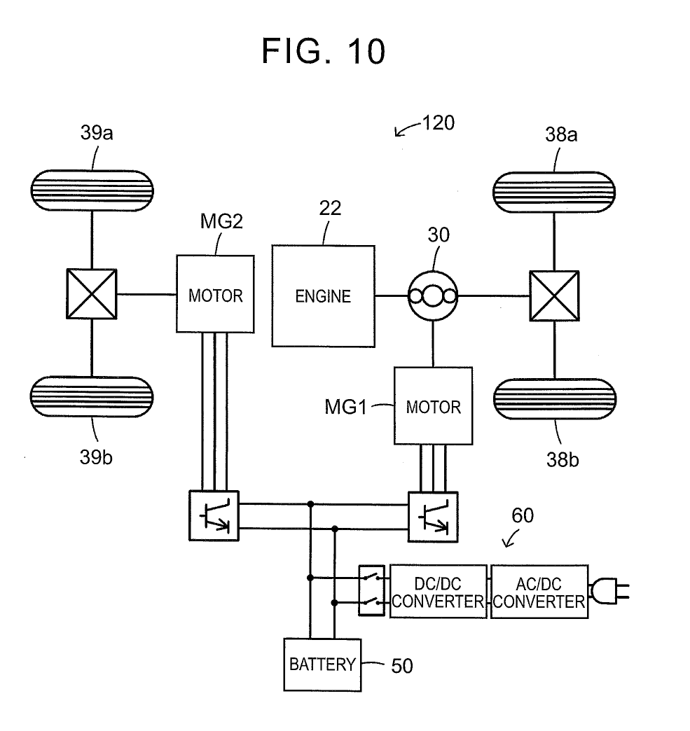

In the hybrid car 20 in the embodiment, the power from the motor MG2 is output to the drive shaft 36. However, as shown by way of example in a hybrid car 120 in a modification in FIG. 10, the power from the motor MG2 may also be connected to an axle shaft (axle shaft connected to wheels 39a and 39b in FIG. 10) different from the axle shaft (axle shaft connected to the drive wheels 38a and 38b) connected to the drive shaft 36.

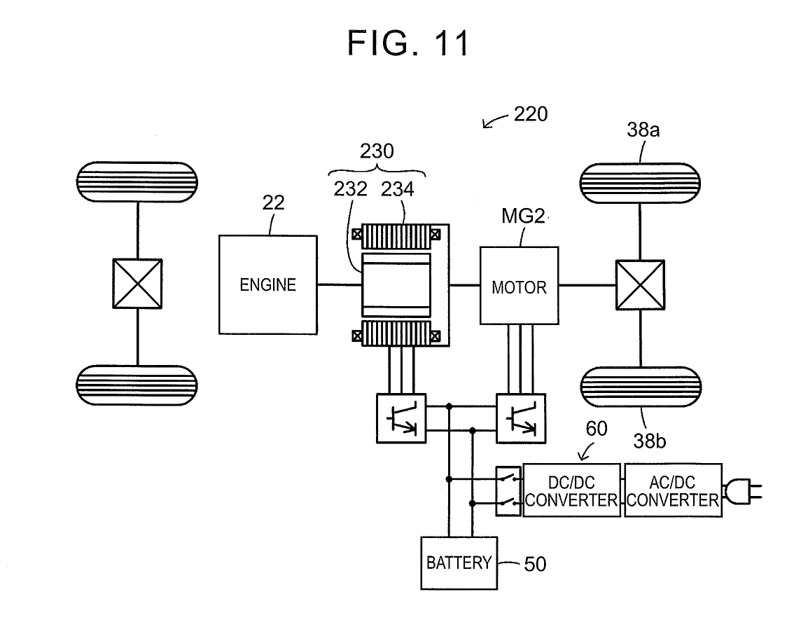

In the hybrid car 20 in the embodiment, the power from the engine 22 is output to the drive shaft 36 connected to the drive wheels 38a and 38b via the planetary gear 30. However, as shown by way of example in a hybrid car 220 in a modification in FIG. 11, the hybrid car 20 may also include a pair-rotor electric motor 230 which has an inner rotor 232 connected to the crankshaft of the engine 22 and an outer rotor 234 connected to the drive shaft 36 that outputs the power to the drive wheels 38a and 38b, and transmits a part of the power from the engine 22 to the drive shaft 36, while converting the remaining power to an electric power.

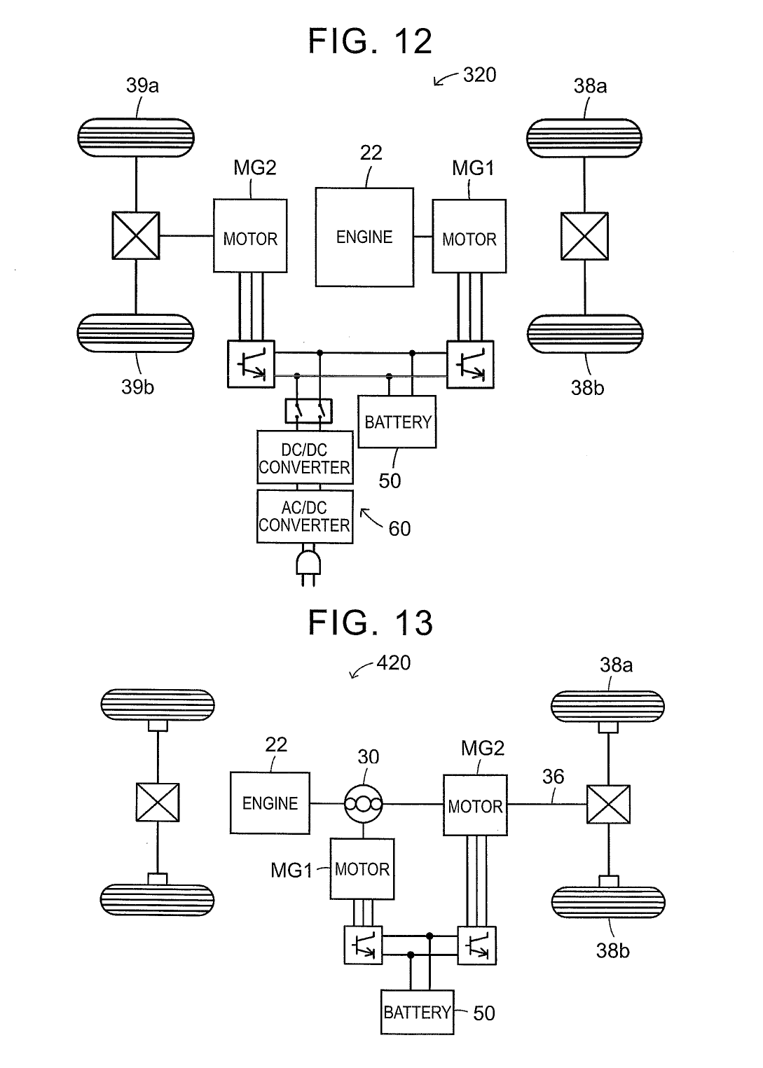

In the hybrid car 20 in the embodiment, the power from the engine 22 is output to the drive shaft 36 connected to the drive wheels 38a and 38b via the planetary gear 30, while the power from the motor MG2 is output to the drive shaft 36. However, as shown by way of example in a hybrid car 320 in a modification in FIG. 12, the hybrid car 20 may also be a so-called series-type hybrid car including the motor MG2 that outputs a power for driving and the motor MG1 that generates electricity with the power from the engine 22. Alternatively, the hybrid car 20 may also have a configuration in which a motor is attached to the drive shaft 36 connected to the drive wheels 38a and 38b via a continuously variable transmission and the engine 22 is connected to the rotation shaft of the motor via a clutch such that the power from the engine 22 is output to the drive shaft via the rotation shaft of the motor and the continuously variable transmission and the power from the motor is output to the drive shaft via the continuously variable transmission. Also, the application of the hybrid car 20 is not limited to a so-called plug-in hybrid car including a charger/discharger 60 having such a DC/DC converter and an AC/DC converter each for converting an AC electric power from an external power source to a DC electric power to charge a battery. As shown by way of example in a hybrid car 420 in a modification in FIG. 13, the hybrid car 20 may also be applied to the hybrid car 420 including the engine 22 and the motor MG1 each connected to the planetary gear 30 and the motor MG2 capable of inputting/outputting the power to/from the drive shaft 36.

A description will be given of the correspondence relationships between main components in the embodiment and the main component of the invention. In the embodiment, the engine 22 corresponds to an “engine”, the motor MG1 corresponds to a “motor”, the high-voltage battery 50 corresponds to a “battery”, the SOC recovery instruction switch 90 corresponds to a “charging acceleration instruction switch”, and the touch panel 98 corresponds to a “reporting device”. Also, the HVECU 70, the engine ECU 24, and the motor ECU 40 correspond to an “electronic control unit”. Among them, the HVECU 70 transmits image information to the touch panel 98 when the SOC recovery instruction switch 90 is ON such that, on the energy information screen of the touch panel 98, the graphic figure G3 showing the high-voltage battery 50 is caused to blink, the range in the graphic figure G3 extending from the line L1 showing the charge-storage-ratio initial value SOCi to the charge-storage-ratio variation dSOC is caused to blink, and the arrow A1 extending from the graphic figure G1 to the graphic figure G2 and the arrow A2 extending from the graphic figure G2 to the graphic figure G3 are displayed.

Here, the “engine” is not limited to an engine which outputs a power using a hydrocarbon-based fuel such as gasoline or light oil. Any engine may be used as long as the engine can output a power for driving, such as a hydrogen engine. The “motor” is not limited to the motor MG1 configured as the synchronous power generating electric motor. Any type of electric motor, such as an induction motor, may be used as long as the electric motor generates electricity using the power from the engine. The “battery” is not limited to the high-voltage battery 50 as the secondary battery. Any battery may be used as long as the battery exchanges an electric power with the motor. The “charging acceleration instruction switch” is not limited to the SOC recovery instruction switch 90. Any switch may be used as long as the switch gives an instruction to increase the electric power generated by the motor after the turning ON of the switch to a level higher than that before the turning ON thereof. The “reporting device” is not limited to the touch panel 98. Any device may be used as long as the device reports information. The “electronic control unit” is not limited to the combination of the HVECU 70, the engine ECU 24, and the motor ECU 40. The “electronic control unit” may also be formed of a single electronic control unit or the like. The “electronic control unit” is not limited to the electronic control unit that controls the engine 22 and the motors MG1 and MG when the SOC recovery instruction switch 90 is ON so as to increase the power storage ratio which is the ratio of the capacity of the electric power that can be discharged from the high-voltage battery 50 to the entire capacity thereof and transmits the image information to the touch panel 98 such that, on the energy information screen of the touch panel 98, the graphic figure G1 showing the high-voltage battery 50 is caused to blink, the range in the graphic figure G3 extending from the line L1 showing the charge-storage-ratio initial value SOCi to the charge-storage-ratio variation dSOC is caused to blink, and the arrow A1 extending from the graphic figure G1 to the graphic figure G2 and the arrow A2 extending from the graphic figure G2 to the graphic figure G3 are displayed. Any electronic control unit may be used as long as the electronic control unit controls the reporting means to report that the charging acceleration mode is ON when the charging acceleration instruction switch is ON.

Note that, since the embodiment is only an example for describing the form for carrying out the invention, the correspondence relationships between the main components in the embodiment and the main component of the invention are not intended to limit the components of the invention. That is, interpretation of the invention should be performed on the basis of the description in each of the sections thereof and the embodiment is only a specific example of the invention.

While the form for carrying out the invention has been described heretofore using the embodiment, the invention is by no means limited to such an embodiment. It will be appreciated that the invention can be practiced in various forms within the scope not departing from the gist thereof.

The invention is applicable to a hybrid vehicle manufacturing industry or the like.

What is claimed is:

1. A hybrid vehicle, comprising:
an engine;
a motor configured to generate electricity using a power from the engine;
a battery configured to exchange an electric power with the motor;
a switch configured to set a charging acceleration mode, and to cancel the charging acceleration mode;
a reporting device configured to report information; and
an electronic control unit configured to:
(a) increase the electric power generated by the motor higher when the charging acceleration mode is set than that when the charging acceleration mode is not set, and
(b) control the reporting device to notify that the charging acceleration mode is set.

2. The hybrid vehicle according to claim 1, wherein
the reporting device displays an image and, when the charging acceleration mode is set, the electronic control unit controls the reporting device to display a predetermined image.

3. The hybrid vehicle according to claim 2, wherein,
when the charging acceleration mode is set, the electronic control unit controls the reporting device such that a color of at least a part of the predetermined image is different from a color thereof when the charging acceleration mode is not set.

4. The hybrid vehicle according to claim 2, wherein,
when the charging acceleration mode is set, the electronic control unit controls the reporting device such that at least a part of the predetermined image blinks.

5. The hybrid vehicle according to claim 2, wherein,
when the charging acceleration mode is set, the electronic control unit controls the reporting device to display an amount of a fuel to be consumed before an amount of the electric power stored in the battery reaches a target power storage amount.

6. The hybrid vehicle according to claim 5, wherein
the electronic control unit controls the reporting device to display a cost of the fuel consumed while the electric power generated by the motor is increased based on the amount of the consumed fuel and a unit price of the fuel.

7. The hybrid vehicle according to claim 1, further comprising:
an external electric power supply device configured to supply the electric power from the battery to an external device when the external device is connected thereto.

8. A control method for a hybrid vehicle including an engine; a motor configured to generate electricity using a power from the engine; a battery configured to exchange an electric power with the motor; a switch configured to set a charging acceleration mode, and to cancel the charging acceleration mode; a reporting device configured to report information; and an electronic control unit, the control method comprising:
(a) increasing, by the electronic control unit, the electric power generated by the motor higher when the charging acceleration mode is set than that when the charging acceleration mode is not set; and
(b) controlling, by the electronic control unit, the reporting device to notify that the charging acceleration mode is set.
